(19) United States
(12) Patent Application Publication
(10) Pub. No.: US 2025/0187869 A1
(43) Pub. Date: Jun. 12, 2025

(54) BUILDING SYSTEM WITH ELEVATOR SYSTEM FOR A MIXED-USE BUILDING

(71) Applicant: INVENTIO AG, Hergiswil (CH)

(72) Inventors: John MIZON, Hampshire (GB); Florian TRÖSCH, Erlenbach ZH (CH); Lukas FINSCHI, Ebikon (CH)

(21) Appl. No.: 18/840,831

(22) PCT Filed: Feb. 16, 2023
(86) PCT No.: PCT/EP2023/053834

§ 371 Date: Aug. 22, 2024

(30) Foreign Application Priority Data
Mar. 10, 2022 (EP) 22161232.8

(51) Int. Cl. B66B 1/24

(52) U.S. Cl. CPC B66B 1/2458; B66B 2201/223

(57) ABSTRACT

An elevator system with an elevator group with a plurality of elevators and a group controller is configured to receive building information from a building management system. For each elevator, the received building information results in an assignment of each elevator to at least one elevator lobby for a specified floor, from which elevator lobby the assigned elevator can be accessed on the specified floor. Building information stored in a memory device of the elevator system is updated with the received building information, wherein, for each elevator, the stored building information indicates an existing assignment of the respective elevator to at least one elevator lobby for the specified floor. Upon receipt of an elevator call, the elevator system is operated according to the updated building information.

### TECHNICAL FIELD

The disclosure described herein relates generally to a building system with an elevator system. Exemplary embodiments of the disclosure also relate to an elevator system and to a method for operating the building system with such an elevator system.

### SUMMARY

Buildings are usually designed and constructed for a single use or for mixed use. A residential building is an example of a single use, as is an office building. A mixed use exists if, for example, a building comprises apartments and commercially used space. An elevator system is planned and installed for the intended use of the building. Depending on the building, the elevator system can have a single elevator, an elevator group or a plurality of elevator groups; in addition, one or more special elevators (e.g., freight elevators) can be provided.

Over time, the originally planned use of the building can change for various reasons. The need for office space or commercial space in general may decline due to changing life and work circumstances, for example. In an office building, for example, vacant space on one or more floors can be converted into apartments. In the event of such a change of use, the elevator system installed in the building remains substantially as it was adapted for the originally planned use of the building.

Although an elevator system remains available for transporting people and goods after a change in use, such a change in use can result in changed requirements for the elevator system. There is therefore a need for a technology that fully or at least partially meets these requirements.

One aspect of the disclosure described herein relates to a method for operating a building system with an elevator system in a building having a plurality of floors. The elevator system can comprise an elevator group with a plurality of elevators and a group controller for the elevator group. The group controller can have an interface device, which can be configured to receive building information from a building management system. According to the method, building information can be received through the group controller interface device. The building management system can transmit the building information to the interface device. For each elevator, the received building information can result in an assignment of each elevator to at least one elevator lobby for a specified floor, from which elevator lobby the assigned elevator can be accessed on the specified floor. Stored building information may be updated with the received building information in a memory device of the elevator system. The stored building information can indicate an existing assignment of each elevator to at least one elevator lobby for the specified floor. Upon receipt of an elevator call entered by a person, the elevator system can be operated according to the updated building information stored in the memory device.

A further aspect concerns a building system for a building with a plurality of floors. The building system can comprise a building management system and an elevator system, which can comprise an elevator group with a plurality of elevators and a group controller for the elevator group. The group controller can have an interface device, which is configured to receive building information from the building management system. The group controller can be configured to receive building information transmitted from the building management system to the interface device. For each elevator, the received building information can result in an assignment of each elevator to at least one elevator lobby for a specified floor, from which elevator lobby the assigned elevator can be accessed on the specified floor. The group controller can be configured to update building information stored in a memory device of the elevator system with the received building information. The stored building information can indicate an existing assignment of each elevator to at least one elevator lobby for the specified floor. In addition, the group controller can be configured to operate the elevator system upon receipt of an elevator call entered by a person in accordance with the updated building information stored in the memory device.

A further aspect relates to an elevator system, which can comprise an elevator group with a plurality of elevators and a group controller for the elevator group. The group controller can have an interface device, which can be configured to receive building information from a building management system. The group controller can be configured to receive building information transmitted from the building management system to the interface device. For each elevator, the received building information can result in an assignment of each elevator to at least one elevator lobby for a specified floor. from which elevator lobby the assigned elevator can be accessed on the specified floor. The group controller can be configured to update building information stored in a memory device of the elevator system with the received building information. The stored building information can indicate an existing assignment of each elevator to at least one elevator lobby for the specified floor. In addition, the group controller can be configured to operate the elevator system upon receipt of an elevator call entered by a person in accordance with the updated building information.

In one exemplary embodiment of the method, of the building system or of the elevator system, the updated building information can be stored in the memory device. The elevator system can be configured according to the updated building information.

According to the disclosure described herein, a building system may be created, the elevator system of which can substantially adapt itself to a changed building use when updated building information is available. This may allow the operation of the elevator system to be adapted in particular to a changed elevator lobby situation on a specified floor. This may avoid the need for an on-site technician to adapt the elevator system to a changed building use.

In other words, this means, for example, that the building system can inform the elevator system via the building information that the elevator system has to change or configure its operation with respect to the specified floor, for example, a call allocation algorithm and/or a control process for car doors. This means, for example, that the building system can determine that a particular elevator lobby may not be served by all elevators, but rather by one or more specific elevators, or which car door is to be opened towards the particular elevator lobby.

In an exemplary embodiment that may be applicable in conjunction with one or more of the exemplary embodiments described herein. configuring can be performed by the group controller. To this end, the group controller can read the updated building information from the memory device, create a dataset therefrom and store it in a memory device of the group controller. The dataset can specifiy for each elevator which elevator lobby it is assigned to on the specified floor.

In an exemplary embodiment that may be applicable in conjunction with one or more of the exemplary embodiments described herein, an elevator can have two elevator doors. The dataset can specify for this elevator to which elevator lobby each of the elevator doors on the specified floor is assigned, wherein an assignment can specify the elevator lobby to which an elevator door will open and close. The disclosure described herein can therefore applicable to both an elevator with one car door and an elevator with two car doors.

In an exemplary embodiment that may be applicable in conjunction with one or more of the exemplary embodiments described herein, the dataset can specify for each elevator operating device arranged on the specified floor which elevator lobby it is assigned to. The dataset can thus map the situation on the specified floor also with regard to the elevator operating devices.

In an exemplary embodiment that may be applicable in conjunction with one or more of the exemplary embodiments described herein, the elevator system can be operated upon receipt of an elevator call entered by the person on the specified floor at an elevator operating device such that the elevator call from the elevator operating device can be received by the group controller, that the elevator lobby to which the elevator operating device is assigned can be determined, and that at least one elevator assigned to this elevator lobby can be determined. This may allow an elevator assigned to the determined elevator lobby to be determined to serve the elevator call, and the elevator controller of the allocated elevator can be controlled to serve the elevator call.

In an exemplary embodiment that may be applicable in conjunction with one or more of the exemplary embodiments described herein, the elevator call can indicates a direction of travel desired by the person or the received elevator call can indicate a destination floor desired by the person. The disclosure described herein may not be limited to a specific control technology; it can be used in an elevator system with a destination call controller and in an elevator system with a conventional up/down direction controller. The elevator call can be a destination call initiated by the person outside the elevator car, wherein the elevator controller ascertains the call input floor and the destination floor from the destination call. This exemplary embodiment concerns an elevator system with a destination call controller. In one exemplary embodiment of an elevator system with a conventional up/down direction control, the elevator call can be a floor call initiated by the person outside the elevator car that indicates a desired direction of travel, wherein the elevator controller ascertains the call input floor from the floor call.

With the disclosure described herein. it can be an advantage that the elevator system can be adapted to a temporary change (possibly limited to days or a few weeks, e.g., during events) with relatively little effort. For example, a separate elevator lobby can be created for a user group during such a period, which can be served by one or more selected elevators. If a high volume of traffic is expected during this period, for example, a larger elevator lobby can be created (while another is reduced in size for this period) and served by a higher number of elevators. The advantage may be that the changes are reversible, for example, if they are no longer required after the event.

In an exemplary embodiment that may be applicable in conjunction with one or more of the exemplary embodiments described herein, at least one installation can be provided by which one elevator lobby can be separated from another elevator lobby. The at least one installation can comprise a partition wall, a barrier and/or separators. The at least one installation can be used alone or in conjunction with security personnel to create the elevator lobbies. In one exemplary embodiment, the separation of elevator lobbies can be carried out solely by security personnel. The separators, which can be in a closed or open state depending on the situation and requirements, can also allow for directing people to the appropriate elevator lobbies in that a separator leading to the elevator lobby is open.

In an exemplary embodiment that may be applicable in conjunction with one or more of the exemplary embodiments described herein, the building system can comprise a sensor system that is in communication with the building management system and that is configured to detect a state of the at least one installation and transmit it to the building management system. The state can indicate whether the at least one installation is open or closed, wherein the building information can comprise the state. This may allow for the recording of status changes to be automated.

In an exemplary embodiment that may be applicable in conjunction with one or more of the exemplary embodiments described herein, the building management system can comprise an input device for manually inputting the state of the at least one installation. The state can indicate whether the at least one installation is open or closed, wherein the building information can comprise the state. The manual input option can be an advantage, for example, if there is no sensor system in the building. A person skilled in the art will recognize that in one exemplary embodiment of a building system, both an input device for manual input and a sensor system can be provided. The manual input option can be used. for example, if security personnel is used to create separate elevator lobbies on short notice.

In the disclosure described herein, according to one or more of the exemplary embodiments described herein, an elevator call can be made with a permanently installed elevator operating device or with a mobile apparatus. The mobile apparatus can be, for example, a (card-like) credential with (RFID) radio technology or an optical code (e.g. QR code), or a cell phone with a corresponding software application, in certain circumstances in conjunction with Bluetooth technology or an optical code. The disclosure described herein can also be particularly applicable when an elevator call is made with such a mobile apparatus, namely without identifying the passenger, because even then the user group can be ascertained with the information relating to the boarding and exiting floor. For example, if passengers want to travel from an access floor (e.g. first floor) to an upper floor, the user group distinguishes the destination floor (exit floor).

### BRIEF DESCRIPTION OF THE DRAWINGS

In the present disclosure, different aspects of the present disclosure are described in greater detail with the help of exemplary embodiments in conjunction with the figures. In the figures, identical elements have identical reference signs. In the drawings:

FIG. 1 shows a schematic representation of an exemplary building system in a building with a plurality of floors and of an exemplary elevator system;

FIGS. 2-5 show schematic representations of the elevator system on a floor with exemplary arrangements of elevator lobbies; and

FIG. 6 shows an exemplary representation of an exemplary embodiment of a method for operating the building system.

### DETAILED DESCRIPTION

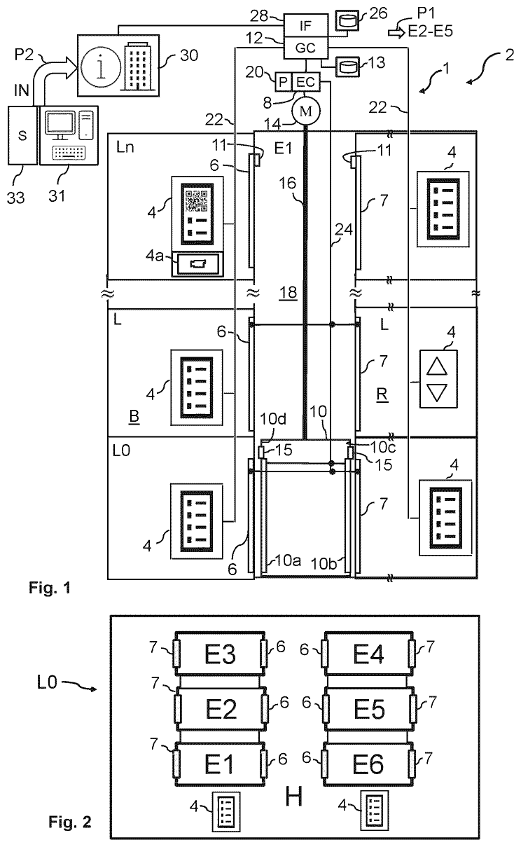

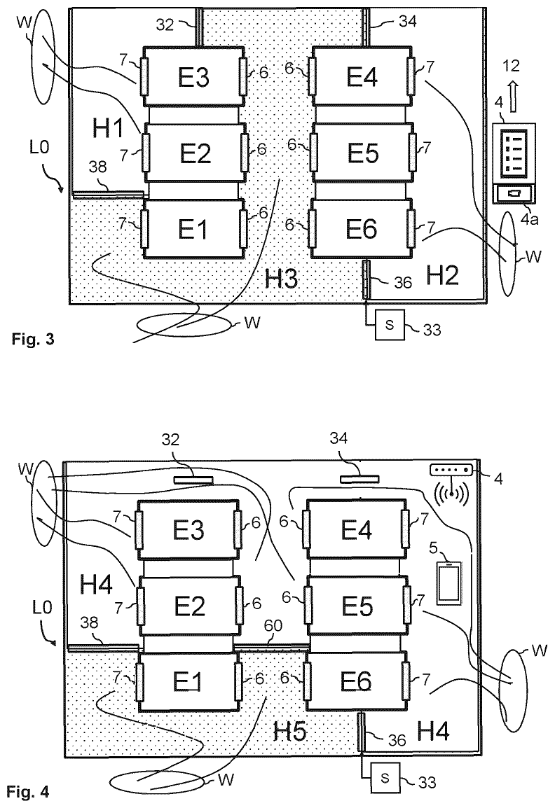

FIG. 1 shows a schematic representation of an exemplary building system in a building 2 that has a plurality of floors L0, L, Ln and an elevator system 1, which can serve the floors L0, L, Ln. The building 2 is shown schematically in a side view, wherein an elevator E1 of the elevator system 1 is visible, which has at least one elevator car 10 that can be moved along an elevator shaft 18. FIG. 2-FIG. 5 each show (for example, at the level of floor L0, which can be provided as a building access floor) a schematic plan view of the elevator system 1, which in one exemplary embodiment can comprise a total of six elevators E1-E6. The six elevators E1-E6 can be combined to form an elevator group which can be controlled by a group controller 12 (GC); this is indicated by an arrow P1 in FIG. 1.

In one exemplary embodiment, each of the elevators El-E6 can be configured analogously to the elevator El shown in FIG. 1, wherein a person skilled in the art will recognize that in another exemplary embodiment one of the elevators E1-E6 can have a different design because it is configured, for example, as a special elevator (e.g., freight elevator) and/or may serve certain floors. In addition to the elevator car 10, the elevator E1 comprises an elevator controller 8 (EC), a drive device 14 (M) and elevator operating devices 4 arranged on the floors L0, L, Ln, where people can enter elevator calls. A person skilled in the art will recognize that the elevator system 1 can also be configured for call inputs using mobile radio devices. The elevator controller 8 can be in communication with the group controller 12 in order to receive control signals from and transmit signals (e.g., status signals) to the group controller 12. The group controller 12 can be in communication with a memory device 26 in order to access data stored therein.

The group controller 12 comprises an interface device 28 (IF) which can be configured to receive building information from a building management system 30. For this purpose, the interface device 28 (IF) can be connected to the building management system 30 directly or indirectly via a line or a communication network for wireless (radio) and/or wired communication. As explained in more detail herein, the building information can comprise data specifying a building use (e.g., floor layout and/or use, position and/or number of elevator lobbies H, H1-H9 (FIG. 2-FIG. 5)); the building information can be documented in a computer-readable building plan. The building information can result in an assignment of each elevator E1-E6 to at least one elevator lobby H, H1-H9 for a specified floor (in the exemplary embodiment described herein, this is floor L0), from which elevator lobby the assigned elevator E1-E6 can be accessed on the specified floor L0.

In the exemplary embodiments described herein, the building 2 can be a building with mixed use in which, for example, there are apartments and commercially used space. The building 2 may have originally been planned for mixed use, but the mixed use may also have arisen over time following a corresponding adaptation or conversion of the building 2. The elevator system 1 can thus be used by a plurality of user groups: residents can, for example, be assigned to a resident user group (“resident” user group), and commercial users can be assigned to a commercial user group (“commercial person” user group); these groups can be divided into subgroups, for example for VIP residents or individual commercial companies. These assignments can be specified in the building information mentioned and can be updated in the building information if necessary. The building information can be updated if the building use changes, in particular if the floor layout, floor use and/or the position or number of elevator lobbies changes. In FIG. 1, the ability to update the building information is shown by an arrow P2 (IN); the update can be carried out by a sensor system 33 and/or a manual input at an input device 31.

The adaptation of the operation of the elevator system 1 can be carried out if, according to the change in use, a plurality of elevator lobbies H, H1-H9 are required on a specified floor L0, from which access to certain elevators E1-E6 should be possible. The need for a plurality of elevator lobbies H, H1-H9 can, for example, be based on the fact that users or user groups can be separated on the specified floor L0 and in particular at the access to the elevator system 1. In a building 2 with apartments and a hotel, such a separation may be desired, for example, for residents of building 2 and hotel guests. A hotel elevator lobby can be designed according to a hotel reception area or a hotel design concept, while an elevator lobby for residential floors can have, for example, an information board for the house rules or the like and can be less elaborately designed.

The elevator system 1 may generally serve an elevator call initiated by a person in that an elevator E1-E6 (or an elevator car 10 of the elevators E1-E6) can transport the person from a boarding floor to a destination floor. In one exemplary embodiment, operation may begin when the elevator call is received, and may end when the person leaves the elevator car 10 on the destination floor. The elevator system 1 can process the received elevator call in order to select, for example, an elevator E1-E6 or a car 10 for a trip and to plan the trip (e.g., travel to the boarding floor and subsequent travel to the destination floor with or without an intermediate stop), and can control the selected elevator car 10 accordingly. According to the disclosure described herein, for the selection of the elevator E1-E6 or the elevator car 10, it can be determined which elevator lobby H, H1-H9 is to be served and, if the elevator car 10 has two elevator doors 6, 7 as in FIG. 1-FIG. 5, which of the elevator doors 6, 7 is to be opened.

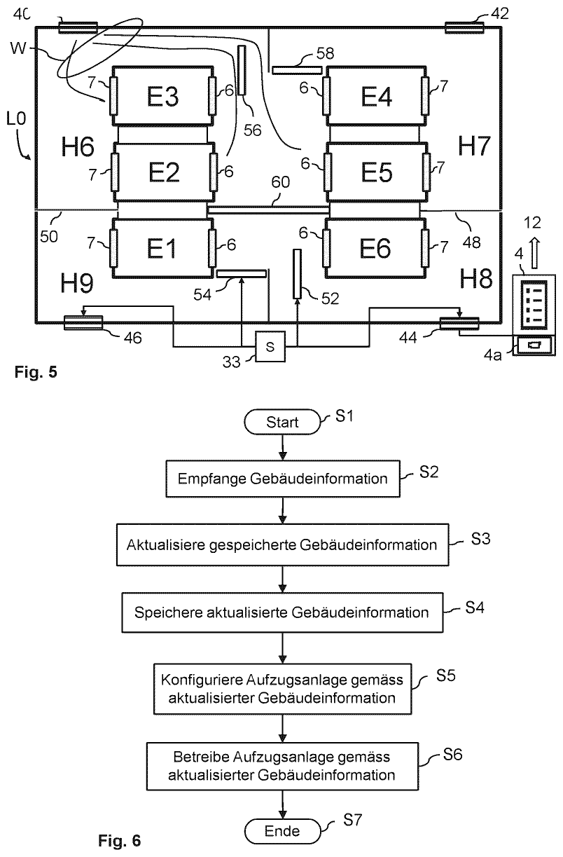

In the exemplary building situation shown in FIG. 1, the disclosure described herein can be used in an advantageous manner. In brief summary and by way of example, the disclosure described herein makes it possible to adapt the operation of an elevator system 1 to a change in the use of a building 2 that occurs over time. As part of such an adaptation, the elevator system 1 can receive building information which the building management system 30 can transmit to the interface device 28 of the group controller 12. The received building information can result in an assignment of each elevator E1-E6 to at least one elevator lobby H, H1-H9 for a specified floor L0, from which elevator lobby the assigned elevator E1-E6 can be accessed on the specified floor L0. The building information stored in the memory device 26 of the elevator system 1 can be updated with the received building information. For each elevator E1-E6, this stored building information can indicate an existing assignment of the respective elevator E1-E6 to at least one elevator lobby H, H1-H9 for the specified floor L0. Before the aforementioned update, the elevator system 1 can operate according to this stored building information. The updated building information can be stored in the memory device 26 and used to configure the elevator system 1 accordingly. Upon receipt of an elevator call entered by a person, the elevator system 1 can operate according to the updated building information. Further details on the configuration of the elevator system and its operation according to the updated building information can be found in conjunction with FIG. 6.

The memory device 26 can comprise a computer-readable storage medium for storing data that can be accessed by the group controller 12. e.g., it can read data from and write data to the memory device 26 (or cause such writing). The group controller 12 can be configured, for example, to store and change or update data in the memory device 26 and to read data from the memory device 12. The stored data can comprise building information, for example, the number of floors L, L, Ln, the number of elevator lobbies H, H1-H9 on a floor L0, L, Ln, in particular on the floor L0, and the assignment of an elevator lobby H, H1-H9 to one or more elevators E1-E6. In particular, the data can represent an assignment situation existing at a given point in time (e.g., the accesses to the elevators E1-E6) on the floor L0. Exemplary assignment situations are shown in FIG. 2-FIG. 5.

The memory device 26 can be an internal data memory of the group controller 12 or, with respect to the group controller 12, an external memory device of the elevator system 1, which is in communication with the group controller 12. The memory device 26 can comprise, for example, a hard disk memory device, a solid state drive (SSD) memory device, a CD memory device and/or a DVD memory device. Such memory devices 26 and their operation, including data organization, reading and writing, are known to a person skilled in the art.

A person skilled in art will recognize that the building management system 30 can be wholly or partially outsourced to an IT infrastructure for so-called cloud computing (colloquially also referred to as “cloud”). This can include, for example, storing data in a remote data center but also executing programs that are installed remotely rather than locally. Depending on the design, a certain functionality can be made available in a (local) computer system of the building 2 or via the “cloud,” for example. For this purpose, a software application or program parts thereof can be executed in the “cloud,” for example. The computer system can then access this infrastructure as required in order to execute the software application.

FIG. 2-FIG. 5 each show a schematic plan view of the elevator system 1, as it exists in one exemplary embodiment on the level of floor L0 of the building 2. In one plan view, the elevators E1-E3 are arranged side by side (substantially in a row next to each other) without any passage between them. The elevators E4-E6 are also arranged in a row next to each other and are located opposite the row of elevators E1-E3, in particular from the perspective of a passenger who is located in a zone between the two rows and recognizes six elevators E1-E6 or their elevator doors 6, 7. In the exemplary embodiments shown, the elevator car 10 of each elevator E1-E6 has two opposite elevator doors 6.,7, wherein the elevator doors 6 can open towards the said zone and the elevator doors 7 can open towards zones which are located, for example, on opposite sides of an elevator car 10. A person skilled in the art will recognize that the disclosure described herein is limited neither to the number of elevators E1-E6 shown nor to their arrangement or to the elevator cars 10 with two elevator doors 6, 7.

Here, floor L0 is the building access floor where people enter and leave the building 2, for example, via one or more external building doors; floor L0 can, for example, be at street level. Depending on the building, there can be a plurality of building access floors on different floors (e.g., also due to different street levels). At least one elevator lobby H, H1-H8 is provided for on the floor L0, from which there is access to the elevators E1-E6. The elevator lobby H, H1-H8 can also be called the entrance hall in building 2. Depending on the building 2, the elevator lobby H, H1-H9 can be directly adjacent to a building door and extend from there to the floor L0, or it can extend from one or more hallways or corridors to the floor L0, wherein at least one of the hallways or corridors lead to a building door. Upon entering the building, a person will reach, for example, the elevator lobby H shown in FIG. 2 and can use one of the elevators E1-E6 from there; to leave the building 2, an elevator E1-E6 takes the person back to the elevator lobby H. The at least one elevator lobby H, H1-H9 can be provided for on the floor L0, in particular in the area of the elevators E1-E6, and can be surrounded, for example, by one or more hallways or corridors. For illustrative purposes, such hallways or corridors are not shown in FIG. 2-FIG. 5.

The representations of floor L0 shown in FIG. 2-FIG. 5 illustrate that the elevator lobby H, H1-H9 and, accordingly, the operation of the elevator system 1 can be adapted to a changed building use according to the disclosure described herein. The situation shown in FIG. 2 can exist, for example, after completion of building 2 and commissioning of the elevator system 1 according to the original construction and building plans. A single elevator operating device 4 can be arranged in the elevator lobby H, or a plurality of (e.g., two) elevator operating devices 4 can be arranged there, as shown in FIG. 2. All elevators E1-E6 can be accessed from the elevator lobby H. This also means that every elevator E1-E6 can serve the elevator lobby H. To operate an elevator call entered at an elevator operating device with a start of travel on the floor L0. the group controller 12 can select one of the elevators E1-E6. The building information stored in the memory device 26 represents the situation shown in FIG. 2.

The exemplary situation shown in FIG. 3 can exist, for example, after a change in use of building 2 and comprise a plurality of elevator lobbies H1, H2, H3, which can be assigned to different users or user groups. In addition to the elevators E1-E6 and the elevator lobbies H1-H3. FIG. 3 shows separators 32, 34, 36, 38, which can be opened or removed or closed or inserted again, as required. The separators 32, 34, 36, 38 can be designed as partitions, doors, sliding doors, barriers, turnstiles or the like; they can be operated (unlock/lock) and/or moved (open/close) manually (e.g., open/close or remove/insert) or controlled by the building management system 30.

FIG. 3 shows the following exemplary situation for the elevator lobbies H1-H3: the elevator lobby H1 provides access to the elevators E2 and E3 (elevator doors 7) and is separated from the elevator lobby H3 by these and the separators 32, 38. The elevator lobby H2 provides access to the elevators E4-E6 (elevator doors 7) and is separated from the elevator lobby H3 by these and the separators 34, 36. The elevator lobby H3, which is separated from the elevator lobbies H1 and H2 by the separators 32, 34, 36, 38 and the elevators E2-E6, provides access to the elevators E1-E6 (elevator doors 6, 7). If the situation shown in FIG. 3 exists in building 2, the building information stored in the memory device 26 maps this situation.

The accesses to the elevators E1-E6 are indicated by various exemplary paths W, wherein the paths W can lead through doors, corridors, barriers to the elevator lobbies H1, H2, H3. In the example shown in FIG. 3, people enter an elevator lobby H1, H2, H3 within a limited area; the paths W are therefore shown bundled in this area. A door or the like can be arranged in such an area, which is shown in FIG. 5.

In the situation shown in FIG. 3, elevator E1 can serve elevator lobby H3, while elevators E2 and E3 can serve elevator lobbies H1 and H3. The elevator lobby H3 can moreover also be served by elevators E4-E6. These elevators E4-E6 can also serve elevator lobby H2. As explained elsewhere in this description, the elevator doors 6, 7 of these elevators E1-E6 are controlled accordingly.

Another exemplary situation is shown in FIG. 4, which can also arise after a change in use of building 2 and which can comprise two elevator lobbies H4, H5, which are assigned to different users or user groups. In one exemplary embodiment, the elevator lobbies H4, H5 can emerge from the situation shown in FIG. 3 by opening or removing the separators 32, 34. In FIG. 4. the separators 32, 34 are shown open (relative to their positions shown in FIG. 3, they are shown rotated by 90° in FIG. 4). A person skilled in the art will recognize that in one exemplary embodiment, the separators 36, 38 can also be opened or removed if necessary; this also applies to the barrier 60 shown in FIG. 4, which can be closed or inserted, if necessary, for example.

FIG. 4 shows the following exemplary situation for the elevator lobbies H4, H5: elevator lobby H4 provides access to the elevators E2-E6 and is separated from the elevator lobby H5 by the separators 36, 38 (cf. FIG. 3), the barrier 60 and the elevator E6. The elevator lobby H5 provides access to the elevators E1, E6. In the situation shown in FIG. 4, elevator E1 can serve elevator lobby H5, while elevator E6 can serve elevator lobbies H4 and H5. The accesses to the elevators E1-E6 are also indicated by various exemplary paths W, analogous to the situation shown in FIG. 3. If the situation shown in FIG. 4 exists in building 2, the building information stored in the memory device 26 maps this situation.

A further exemplary situation is shown in FIG. 5, as may also exist after a change in use of building 2 and comprise a plurality of elevator lobbies H6, H7, H8, H9, which are assigned to different users or user groups. In the exemplary embodiment shown, the elevator lobbies H6-H9 can each be entered through an entrance 40, 42, 44, 46. The paths W shown as examples lead from the entrance 40 to the elevator lobby H6, from where there is access to the elevators E2-E5; this applies analogously to the entrances 42-46 and the elevator lobbies H7-H9. A person skilled in the art will recognize that more than one entrance 40-46 can be provided for one elevator lobby H6-H9. The entrances 40-46 can lead to other building zones, or they can be entrances and exits of building 2. Depending on their location and purpose. the entrances 40-46 can comprise doors, sliding doors. turnstiles, barriers, etc. An access control can be carried out at the entrances 40-46: depending on building 2, people can also enter elevator calls at the entrances 40-46, possibly in conjunction with the access control and authorization credentials.

In addition to the entrances 40-46, FIG. 5 shows partition walls 48, 50, the barrier 60 (FIG. 4) and separators 52, 54, 56, 58. In the situation shown. the partition walls 48, 50 and the barrier 60 separate elevators E1 and E6 from the elevators E2-E5, wherein the partition walls 48, 50 can be configured as substantially permanent boundaries, e.g., they may not be configured for opening and closing as needed, whereas the barrier 60 can be configured for such opening and closing.

FIG. 5 shows the following exemplary situation for the elevator lobbies H6-H9: the elevator lobby H6 provides access to the elevators E2-E5. the elevator lobby H7 provides access to the elevators E4, E5, the elevator lobby H8 provides access to the elevators E1, E6, and the elevator lobby H9 provides access to the elevator E1. If the situation shown in FIG. 5 exists in building 2, the building information stored in the memory device 26 maps this situation. FIG. 5, in particular, shows that the separators 52, 54, 56, 58 alone or in conjunction with the partition 60 can be used to create elevator lobbies of different sizes and different elevator assignments, as required and reversibly.

A person skilled in the art will recognize that the situation shown in FIG. 4 can result from the situation shown in FIG. 2 or from the situation shown in FIG. 3, Here, the building information stored in the memory device 26, which maps the situation shown in FIG. 2 or in FIG. 3, is updated with the (current) building information transmitted by the building management system 30. After this update, the memory device 26 stores the data of the building information that maps the situation shown in FIG. 4. A person skilled in the art will also recognize that the situation shown in FIG. 4 can be reversible, e.g., that, if necessary, the situation shown in FIG. 2 (initial situation) can be restored, wherein also a corresponding update of the building information in the memory device 26 takes place. The same applies to the situations shown in FIG. 2 and FIG. 3.

A change in use of a building can be documented in the building management system 30. for example, in a (digitized) building plan. According to one exemplary embodiment, the building management system 30 can have an input device 31 (e.g., a computer terminal) where a person in charge of building 2 can manually enter the changes resulting from the change in use of the building. The person in charge can make the appropriate entries if the desired elevator lobbies H1-H9 exist.

The elevator lobbies H1-H9 can be created, for example, by building or installing (slidable and/or foldable) partitions, doors, sliding doors, barriers, (slidable) curtains or similar visual protection devices or by opening or closing these devices. Depending on the design of these devices, they can comprise electrically controllable activation and/or drive units with which they can be unlocked/locked and/or opened/closed. In one exemplary embodiment, one or more of the elevator lobbies H1-H9 can be created by providing security personnel. The inputs made by the person in charge can also comprise a state (open/closed or unlocked/locked) of, e.g., a door, a sliding door or a barrier.

In one exemplary embodiment, the changes can be detected by the sensor system 33 and transmitted to the building management system 30. The sensor system 33 can, for example, detect the (current) state (e.g., open/closed) of one of the mentioned devices (e.g., sliding door) provided in building 2 for creating the elevator lobbies H1-H9. The sensor system 33 can detect a corresponding number of states in a plurality of these devices. The sensor system 33 can comprise, for example, an electrical door contact switch (wired or wireless (radio)), a light barrier, a proximity switch or an optical monitoring device (video camera with associated image processing and evaluation device (including image processing software)). For illustration, the sensor system 33 is shown in FIG. 3 and FIG. 4 in connection with the separator 36, and in FIG. 5 in connection with the separators 52, 54 and the inputs 44, 46. A person skilled in the art will recognize that the sensor system 33 can also be connected to the other separators 56, 58, 60 and inputs 40, 42.

The changes can, for example, relate to one of the situations shown in FIG. 3-FIG. 5 and indicate the associated assignments, for example, that in FIG. 3 the car doors 7 of the elevators E2, E3 are assigned to the elevator lobby H1 and the car doors 6 of these elevators E2, E3 are assigned to the elevator lobby H3, etc. Once the changes have been entered, the building information updated in this way may be stored; the building information stored in the building management system 30 may thus determine the current situation in building 2. The building management system 30 can then transmit the data relating to the building information to the interface device 28 of the elevator system 1, thereby causing the building information to be updated in the memory device 26 of the elevator system 1. Devices for transmitting data are known to a person skilled in the art; these devices can use wireless (radio) and/or wired communication technologies.

FIG. 1 shows various designs of the elevator operating devices 4 that can be used in the building 2 or the elevator system 1. In an arrangement of the elevators E1-E6 as shown in FIG. 2, for example, an elevator operating device 4 can be arranged, for example on a building wall or an elevator door frame on the specified floor L0 in the area of each elevator E1-E6 (or in the area of a plurality of elevators). In one exemplary embodiment, an elevator operating device 4 can be arranged standing on the floor. Since the elevator operating devices 4 can be in communication with the group controller 12, it can be recognized at which elevator E1-E6 and in which elevator lobby H (e.g., FIG. 2) the person is located when making the call. For example, a desired direction of travel can be entered on such an elevator operating device 4. Once an elevator E1-E6 allocated to the elevator call is ready for boarding at the specified floor L0, the person can enter the elevator car 10 and can enter the desired destination floor on an elevator operating device.

In another exemplary embodiment, a desired destination floor can be entered on an elevator operating device 4; two elevator operating devices 4 are shown for this purpose in FIG. 2. In the elevator system 1, this can represent a destination call. e.g., in addition to the destination floor, the boarding floor results from the location of the elevator operating device 4. The group controller 12 can determine an elevator E1-E6 for the destination call. An allocation algorithm known to a person skilled in the art can be used for this purpose. The person can be informed of the allocated elevator E1-E6, e.g., with the elevator operating device immediately after the call is entered, so that he or she can go to the allocated elevator E1-E6.

Exemplary elevator operating devices 4 are also shown in FIG. 3-FIG. 5, wherein for reasons of representation only, a single elevator operating device 4 is shown therein. In FIG. 3, the elevator operating device 4 shown is arranged in the area of the elevator lobby H2, in particular where the paths W lead into the elevator lobby H2. In this area, the elevator operating device 4 can be arranged on a building wall or on the floor. In FIG. 5, the elevator operating device 4 shown is arranged at or in the area of a door or barrier of the entrance 44 to the elevator lobby H8. A person skilled in the art will recognize that corresponding elevator operating devices 4 are provided for the elevator lobbies H1, H3 in FIG. 3 and the elevator lobbies H6, H7, H9 in FIG. 5, and that more than one elevator operating device 4 can be provided for an elevator lobby H1-H9. These elevator operating devices 4 are in communication with the group controller 12, which is indicated by an arrow pointing in the direction of the group controller 12. The exemplary elevator operating device 4 shown in FIG. 3 and FIG. 5 has a display device that indicates destination floors and is configured with a code scanner 4a for detecting an optical code (e.g., bar code or QR code).

In the situation shown in FIG. 4, the elevator system 1 is configured for call input using a mobile device 5. A transmitting and receiving device for radio signals is arranged on the floor L0 for this purpose, which is arranged, for example, in an elevator operating device 4 (shown as a radio device in the elevator lobby H4 in FIG. 4). The mobile device 5 can be, for example, a mobile phone with an installed software application (app) for elevator operation. If the mobile phone is located in the elevator lobby H4, it communicates with the radio device of the elevator operating device 4 there (e.g., according to Bluetooth technology). This ensures, among other things, that the mobile phone is located in the elevator lobby H4 when the call is entered. A person skilled in the art will recognize that a corresponding elevator operating device 4 is provided for the elevator lobby H5, and that more than one such elevator operating device 4 can be provided for an elevator lobby H4, H5.

In one exemplary embodiment, the mobile device 5 can be, for example, a (card-shaped) credential with, for example, RFID radio technology or an optical code (e.g., bar code or QR code). The mobile phone mentioned can also be configured with a code scanner (camera) to read an optical code displayed in an elevator lobby (e.g., on an elevator operating device 4), or it can have a function to display an optical code that can be read by an elevator operating device 4. Depending on the option or options used in the building 2, the elevator system 1 can be accordingly configured on the floor and/or in the car; such designs are known to a person skilled in the art.

With the understanding of the elevator system 1 described herein and its functionalities, a description of an exemplary method for operating the elevator system 1 is given with reference to FIG. 6. The elevator system 1 and the building 2 are configured as shown by way of example in FIG. 1. The memory device 26 stores building information corresponding to an existing building use; for each elevator E1-E6, this stored building information indicates an existing assignment of the respective elevator E1-E6 to at least one elevator lobby H, H1-H4 for the specified floor L0. As stated above, the operation of the elevator system 1 is carried out according to this stored building information before an update. FIG. 6 illustrates the method with an exemplary flowchart with a number of steps. A person skilled in the art will recognize that the division into these steps is by way of example, and that one or more of these steps can be divided into one or more sub-steps, or that a plurality of the steps can be combined into one step. Some steps can also be performed in a different order than shown, and some steps can be performed substantially simultaneously.

The method according to FIG. 6 begins with a step S1 and ends with a step S7. The building information is received in a step S2. The building management system 30 transmits the building information to the interface device 28 of the group controller 12. The received building information results in an assignment of each elevator E1-E6 to at least one elevator lobby H, H1-H9 for the specified floor L0, from which elevator lobby the assigned elevator E1-E6 can be accessed on the specified floor L0.

In a step S3, the building information stored in the memory device 26 of the elevator system 1 is updated with the received building information. As stated above, for each elevator E1-E6, the stored building information indicates an existing assignment of the respective elevator E1-E6 to at least one elevator lobby H, H1-H9 for the specified floor L0. In a step S4, the updated building information is stored in the memory device 26. A person skilled in the art will recognize that steps S3 and S4 can be combined into one step, for example, updating can be accompanied by saving.

In the exemplary embodiment shown, the elevator system 1 is configured in a step S5 according to the building information updated in step S4. In one exemplary embodiment, the group controller 12 recognizes that updated building information is stored in the memory device 26. This can be carried out, for example, by querying the memory device 26 at regular intervals as to whether there are any data changes, or by receiving a data change message from the memory device 26.

In one exemplary embodiment, the elevator system 1 can configure itself. For this purpose, the group controller 12 can read the updated building information stored in the memory device 26. Since the building information for the specified floor L0 may specify for each elevator E1-E6 its assignment to at least one elevator lobby H, H1-H9, the group controller 12 can determine which elevator E1-E6 can serve which elevator lobby H, H1-H9 on the specified floor L0. In FIG. 1-FIG. 5, the elevators E1-E6 on the specified floor L0 each have two elevator doors 6, 7; the group controller 12 therefore can determine for each elevator E1-E6 which elevator door 6, 7 will open and close to which elevator lobby H, H1-H9 on the specified floor L0. The group controller 12 can store the above-mentioned specifications in the form of a table or as a dataset of assignment rules, e.g., in an internal memory device 13 of the group controller 12. The dataset can specify for each elevator E1-E6, which elevator lobby H, H1-H9 it is assigned to on the specified floor L0. This may allow a computer unit to quickly access the system when an elevator E1-E6 is to be designated to respond to an elevator call. A person skilled in the art will recognize that, as an alternative to such a configuration with an internal storage, the group controller 12 can directly read the (current) building information stored in the memory device 26 for call allocation and can carry out the call allocation accordingly.

In one exemplary embodiment, the configuration of the elevator system 1 can also comprise the elevator operating devices 4 on the specified floor L0. If there is an elevator operating device 4 on each elevator E1-E6, configuration of these elevator operating devices 4 may not be necessary, since the assignments described in connection with FIG. 3-FIG. 5 refer to the elevators. However, if an elevator operating device 4 is assigned to a plurality of elevators E1-E6 prior to a change in use of the building, it can be determined to which elevator E1-E6 or which elevators E1-E6 it will be assigned after the change in use. This can also apply if additional elevator operating devices 4 are mounted in connection with the modification of the elevator lobbies. Their arrangement can be selected depending on the situation; they can be connected to the group controller 12 via wired and/or wireless connections. Depending on the design, each of these elevator devices 4 can have an individual identifier, which can comprise the building information. With reference to the situation shown in FIG. 4, the building information can indicate that, for example, the elevator operating device 4 (with a certain identifier) is located in the elevator lobby H4 on the specified floor L0. According to one exemplary embodiment, the above-mentioned dataset can specify for each elevator operating device 4 arranged on the specified floor L0 which elevator lobby H, H1-H9 it is assigned to.

In a step S6, the elevator system 1 is operated according to the updated building information upon receipt of an elevator call entered by a person. The group controller 12 receives the elevator call from an elevator operating device 4, at or via which the entry of the call is carried out by the person. The elevator operating device 4 is identified, for example, by its identifier. Since the building information stored in the elevator system 1 comprises the location of the elevator operating device 4, the call input floor can be determined from this. If the entry of the call is carried out on the specified floor L0, it is also possible to determine the elevator lobby assigned to this elevator operating device 4 from the stored building information. The information thus determined (call input floor and elevator lobby) results in at least one elevator E1-E6 that can serve this elevator lobby.

If the entry of the call is carried out on the specified floor L0, for example, at the elevator operating device 4 shown in FIG. 5 at the entrance 44 to the elevator lobby H8, elevators E1, E6 can respond to this elevator call. Thus, in order to respond to the elevator call, the group controller 12 can select one of these elevators E1, E6. e.g., it assigns the elevator call to one of these elevators E1, E6 and sends a corresponding control signal to the elevator controller 8 (FIG. 1), which then controls the elevator car 10. Since the elevator car 10, as explained herein, has two elevator doors 6, 7 in the exemplary embodiments of this description, the control signal can contain information as to which elevator door 6, 7 is to be opened. If, for example, elevator E1 is assigned in the situation shown in FIG. 5, its elevator door 6 can be opened because it opens to the elevator lobby H8.

Further exemplary configurations of the building 2 shown in FIG. 1 and its elevator system 1 are given herein. The upper floors (Ln) can, for example, be exclusively residential floors, each having at least one apartment, and the lower floors (L0) can be exclusively commercially used floors (hereinafter also referred to as commercial floors). In addition to these exclusive uses, a part of the building on one floor can be used for at least one apartment (“residential part of the building”) and another part of the building can be used for commercial purposes (“commercial part of the building”). For example, a business can use one or more floors L0, L. If there is a plurality of floors, these can be consecutive in the vertical direction, e.g., the business uses the neighboring floors L0 and L, but one or more floors can also be non-consecutive. e.g., there is at least one floor not used by the business between two floors used by the business. In the latter case, a floor not used by this business can be used by another business or for one or more apartments; on this unused floor, one part of the building can be used for residential purposes and another part of the building for commercial purposes. A person skilled in the art will recognize that, like the commercial floors, the residential floors may not be consecutive.

A person skilled in the art will also recognize that the disclosure described herein is not limited to mixed use by apartments and businesses, but also includes sole use by commercial users (e.g., various businesses). For example, one or more floors or parts of a building can be used by a hotel company, while other floors or parts of a building on these floors can be used by other businesses (e.g., stores, law firms. etc.).

The elevator system 1 installed in the building 2 can be configured to serve the floors L0, L, Ln in accordance with the usage scenarios described herein. Residents of the apartments can use the elevator system 1 to be transported from one residential floor (residential part of the building) to another residential floor (residential part of the building) or to a building access floor (elevator lobby), or to be transported from the elevator lobby to a residential floor (residential part of the building). Accordingly, persons (e.g., employees, hotel guests, visitors, etc.) who use the floors for commercial purposes can be transported between the individual commercial floors and between the commercial floors and the elevator lobby. A person skilled in the art will recognize that the elevator system 1, possibly in conjunction with an access control system, can be configured to detect and verify credentials before a resident or other person can be transported to a floor.

In the exemplary situation shown in FIG. 1, a part of the building B to the left of the elevator shaft 18 on the floor L, for example, can be used for commercial purposes. Persons therefore can use the elevator system 1 from this left-hand commercial part of the building B, e.g., while a person is in the commercially used commercial part of the building B, they input an elevator call there, for example, and then board the elevator car 10 that serves the elevator call from there. In FIG. 1, a residential part of the building R to the right of the elevator shaft 18 can be used for residential purposes. The residents therefore can use the elevator system 1 from this (right-hand) residential part of the building R. The parts of the building B and R can be separated from one another by structural measures (e.g., walls). A person skilled in the art will recognize that other floors L0, Ln can also be divided into parts of the building. As explained herein, the elevator system 1 can recognize on which floor L0, L, Ln and in which part of the building B, R an elevator call is input and which destination (floor L0 ,L, Ln, and/or part of the building B, R) a passenger has.

The use of the building 2, for example, its division into floors L0, L, Ln, the arrangement of any parts of the building B, R and the accesses to the building 2 and the elevator system 1, can be defined in a building plan in one exemplary embodiment. The building plan can be stored in electronic form in the elevator system 1 or in the building management system 30. The elevator system 1 can use this saved building plan, for example, when planning an elevator ride. If, for example, the use and/or layout of the floors L0, L, Ln or parts of the building B, R changes in the building 2, the building plan can be updated at a central location.

The elevator controller 8 can be connected to a positioning device 20 (P); they can, for example, be combined in one unit and arranged at a central location in the elevator shaft 18 (e.g., in the shaft head); they can also be arranged separately and/or distributed. Functions of the elevator controller 8 can also be carried out in whole or in part by the elevator operating devices 4 and/or by components of the elevator car 10 or components arranged thereon. Instead of a traction elevator (shown in FIG. 1), the elevator system 1 can also have one or more hydraulic elevators.

The elevator car 10 shown in FIG. 1 by way of example has a car door 10a on a car wall 10d and a car door 10b on a car wall 10c. FIG. 1 also shows a number of elevator doors 6, 7 which separate the elevator shaft 18 from the floors L0, L, Ln. In one exemplary embodiment, an elevator door 6, 7 can open and close by being coupled to one of the car doors 10a, 10b if the elevator car 10 is located on the floor L0, L, Ln and can thereby be moved by the car door 10a, 10b. In the shown exemplary embodiment, the car doors 10a, 10b and the elevator doors 6, 7 are connected to the elevator controller 8 via a communication network 24.

A communication network 22 can connect the elevator operating devices 4 to the group controller 12 and thus may make communication possible between the group controller 12 and the elevator operating devices 4. For this communication, the elevator operating devices 4 and the group controller 12 can be directly or indirectly connected to the communication network 22.

The communication networks 22, 24 can each comprise a communication bus system, individual point-to-point lines, or a combination thereof. Depending on the implementation of the communication networks 22, 24, the group controller 12, the elevator controller 8, each elevator operating device 4, each car door 10a, 10b and each elevator door 6, 7 can be assigned individual addresses and/or identifiers, so that, for example, the elevator controller 8 can address and send a message specifically to a particular elevator operating device 4 or a control signal to a particular car door 10a, 10b. Communication can take place in accordance with a protocol for wired communication. for example, the Ethernet protocol. With the addressing or the point-to-point line connection described herein. the group controller 12 (e.g., in conjunction with the building plan described herein) can recognize, among other things, on which floor L0, L, Ln, in which part of the building (B, R) and at which elevator operating device 4 a resident or other person inputs an elevator call. The recognized floor L0, L, Ln or the recognized part of the building (B, R) can specify a boarding location (boarding floor and boarding side into the car 10) for a desired ride to a destination floor.

The elevator installation 1 can be equipped with an up/down controller (also direction controller) or a destination call controller, for example. A person skilled in the art recognizes that mixed forms of the control technologies described herein can also be possible. If the elevator system 1 is equipped with an up/down controller, elevator operating devices 4 can be arranged on the floors L, L0, Ln on each of which an elevator call (also floor call or direction call) can be input for a desired direction of travel. For illustration purpose, such an elevator operating device 4 is shown in FIG. 1 on the floor L in the part of the building R. The boarding floor or the part of the building B, R on this boarding floor can be determined by the location of the elevator operating device 4. which is documented in the building plan, for example. The desired destination floor can then input in the car 10 on an elevator operating device arranged there (not shown in FIG. 1); such a call input can also be referred to as a car call. A communication line (24) can connect the (car-side) elevator operating device to the elevator controller 8. The drive controller 14 can control the travel of the elevator car 10 according to the destination floor input in the car 10.

If the elevator system 1 is equipped with a destination call controller, elevator operating devices 4 can be arranged on the floors L, LO, Ln on which a passenger P can input a desired destination floor; a destination call can then be registered as an elevator call. For illustration purposes, such elevator operating devices 4 are shown in FIG. 1 on floors L0, Ln and on floor L in the part of the building B. Once the passenger has entered the destination floor, information may be available about the boarding floor, the destination floor and, on the specified floor L0, the elevator lobby H, H1-H9. The boarding floor (including the building part B, R on said boarding floor or elevator lobby H, H1-H9) can be determined by the location of the elevator operating device 4 (e.g., from the building plan) at which the destination floor is entered. The group controller 12 shown in FIG. 1 comprises a destination call controller that assigns an elevator car 10 to the entered destination call. The elevator controller 8 can control the movement of the elevator car 10 according to the destination call. 1-14. (canceled)

15. A method for operating a building system with an elevator system in a building having a plurality of floors, wherein the elevator system comprises an elevator group with a plurality of elevators and a group controller for the elevator group, wherein the group controller comprises an interface device configured to receive building information from a building management system, wherein the method comprises:
receiving the building information by the interface device of the group controller, wherein the building management system transmits the building information to the interface device and wherein, for each elevator of the plurality of elevators, the building information received results in an assignment of the respective elevator of the plurality of elevators to at least one elevator lobby for a specified floor, from which elevator lobby the assigned elevator of the plurality of elevators is accessed on the specified floor;
updating stored building information stored in a memory device of the elevator system with the building information received, wherein, for each elevator, the stored building information indicates an existing assignment of the respective elevator to at least one of the at least one elevator lobby for the specified floor; and
operating the elevator system upon receipt of an elevator call entered by a person according to the stored building information stored in the memory device updated by the building information received.

16. The method of claim 15, further comprising configuring, with the group controller, the elevator system according to the stored building information updated, wherein the group controller reads the stored building information updated from the memory device, generates a dataset therefrom and stores the dataset in a group controller memory device of the group controller, wherein the dataset specifies for each elevator of the plurality of elevators which elevator lobby it is assigned to on the specified floor.

17. The method of claim 16, wherein at least one elevator of the plurality of elevators comprises two elevator doors, wherein the dataset for the at least one elevator of the plurality of elevators comprising two elevator doors specifies to which elevator lobby each of the two elevator doors on the specified floor is assigned, wherein an assignment indicates the at least one elevator lobby to which each of the two elevator doors will open and close.

18. The method of claim 16, wherein the dataset specifies for each elevator operating device arranged on the specified floor which of the at least one elevator lobby it is assigned to.

19. The method of claim 17, wherein the dataset specifies for each elevator operating device arranged on the specified floor which of the at least one elevator lobby it is assigned to.

20. The method of claim 18, wherein operating the elevator system upon receipt of the elevator call entered by the person on the specified floor with an elevator operating device comprises:
receiving the elevator call from the elevator operating device by the group controller,
determining, by the group controller, the at least one elevator lobby to which the elevator operating device is assigned,
determining, by the group controller, at least one elevator of the plurality of elevators assigned to this at least one elevator lobby,
assigning, by the group controller, the at least one elevator of the plurality of elevators assigned to the at least one elevator lobby to serve the elevator call; and
controlling, by the group controller, an elevator controller of the at least one elevator of the plurality of elevators assigned to the at least one elevator lobby to serve the elevator call.

21. The method of claim 20, wherein the elevator call received indicates a direction of travel desired by the person, or wherein the elevator call received indicates a destination floor desired by the person.

22. A building system for a building with a plurality of floors comprising:
a building management system; and
an elevator system comprising an elevator group with a plurality of elevators and a group controller for the elevator group, wherein the group controller has an interface device, which is configured to receive building information from the building management system, wherein the group controller is configured to:
receive the building information transmitted from the building management system to the interface device, wherein, for each elevator of the plurality of elevators, the building information received results in an assignment of the respective elevator of the plurality of elevators to at least one elevator lobby for a specified floor, from which elevator lobby the assigned elevator of the plurality of elevators is accessed on the specified floor;
update stored building information stored in a memory device of the elevator system with the building information received, wherein, for each elevator of the plurality of elevators, the stored building information indicates an existing assignment of the respective elevator of the plurality of elevators to at least one of the at least one elevator lobby for the specified floor; and
operate the elevator system upon receipt of an elevator call entered by a person according to the stored building information stored in the memory device updated by the building information received.

23. The building system of claim 22, wherein the group controller is configured to store the stored building information updated in the memory device and to configure the elevator system according to the stored building information updated, wherein the group controller comprises a group controller memory device which is configured to store a dataset which specifies for each elevator of the plurality of elevators which elevator lobby it is assigned to on the specified floor.

24. The building system of claim 23, wherein at least one elevator of the plurality of elevators comprises two elevator doors on the specified floor, wherein the dataset for each elevator of the plurality of elevators comprising two elevator doors specifies to which elevator lobby each of the two elevator doors on the specified floor is assigned, wherein an assignment indicates the at least one elevator lobby to which each of the two elevator doors will open and close.

25. The building system of claim 23, wherein the elevator system comprises elevator operating devices arranged on the plurality of floors, wherein the dataset specifies for each elevator operating device arranged on the specified floor which of the at least one elevator lobby it is assigned to.

26. The building system of claim 24, wherein the elevator system comprises elevator operating devices arranged on the plurality of floors, wherein the dataset specifies for each elevator operating device arranged on the specified floor which of the at least one elevator lobby it is assigned to.

27. The building system of claim 25, wherein the elevator operating devices comprise a call device configured for inputting a direction of travel or for inputting a destination floor.

28. The building system of claim 22, further comprising at least one device with which one elevator lobby is separated from another elevator lobby, wherein the at least one device comprises at least one of a partition wall, a barrier or separators.

29. The building system of claim 23, further comprising at least one device with which one elevator lobby is separated from another elevator lobby, wherein the at least one device comprises at least one of a partition wall, a barrier or separators.

30. The building system of claim 24, further comprising at least one device with which one elevator lobby is separated from another elevator lobby, wherein the at least one device comprises at least one of a partition wall, a barrier or separators.

31. The building system of claim 28, further comprising a sensor system, which is in communication with the building management system and which is configured to detect a state of the at least one device and to transmit it to the building management system, wherein the state indicates whether the at least one device is open or closed, and wherein the building information comprises the state.

32. The building system of claim 28, wherein the building management system comprises an input device for manually entering a state of the at least one device, wherein the state indicates whether the at least one device is open or closed, and wherein the building information comprises the state.

33. The building system of claim 31, wherein the building management system comprises an input device for manually entering a state of the at least one device, wherein the state indicates whether the at least one device is open or closed, and wherein the building information comprises the state.

34. An elevator system, comprising:
an elevator group with a plurality of elevators; and
a group controller for the elevator group, wherein the group controller has an interface device, which is configured to receive building information from a building management system, wherein the group controller is configured to:
receive the building information transmitted from the building management system to the interface device, wherein, for each elevator of the plurality of elevators, the building information received results in an assignment of the respective elevator of the plurality of elevators to at least one elevator lobby for a specified floor, from which elevator lobby the assigned elevator of the plurality of elevators is accessed on the specified floor;
update stored building information stored in a memory device of the elevator system with the building information received, wherein, for each elevator of the plurality of elevators, the stored building information indicates an existing assignment of the respective elevator of the plurality of elevators to at least one of the at least one elevator lobby for the specified floor; and
operate the elevator system upon receipt of an elevator call entered by a person according to the stored building information stored in the memory device updated by the building information received.
